(19) United States
(12) Patent Application Publication
(10) Pub. No.: US 2026/0307478 A1
(43) Pub. Date: Oct. 8, 2026

(54) Axle Disconnect

(71) Applicant: WARN Automotive, LLC, Milwaukie, OR (US)

(72) Inventor: Bryan Yoder, Corvallis, OR (US)

(21) Appl. No.: 19/639,733

(22) Filed: Apr. 6, 2026

Related U.S. Application Data
(60) Provisional application No. 63/783,336, filed on Apr. 4, 2025.

(51) Int. Cl. B60K 23/08

(52) U.S. Cl. CPC B60K 23/08; B60K 2023/0858

(57) ABSTRACT

An actuator assembly for an axle disconnect includes a solenoid and a latching system. The solenoid includes an electromagnetic coil arranged within a housing, and a solenoid core that moves between a first and second axial position. The latching system is connected to the solenoid, and includes a support ring, a latching ring, and an indexing ring. The support ring is fixed to the housing and includes a first set of teeth extending in a first axial direction. The latching ring has a second set of teeth extending in a second axial direction toward the support ring, and a third set of teeth extending in the first axial direction away from the support ring, and the latching ring connects to the solenoid core. The indexing ring is fixed to the housing and has a fourth set of teeth extending in the second axial direction toward the latching ring.

### CROSS-REFERENCE TO RELATED APPLICATION

This application claims priority under 35 U.S.C. § 119 to U.S. Application Serial No. 63/783,336, filed on Apr. 4, 2025, the entire contents of which is incorporated by reference herein.

### FIELD

The present disclosure relates to a axle disconnect systems, such as wheel end disconnect actuators for coupling and decoupling a clutch from an axle.

### BACKGROUND

Modern vehicles often incorporate one or more drivetrain modes for providing power from an engine to the driven wheels. For example, a vehicle with only a two-wheel drive system (2WD), or 4×2 mode, may provide power via one or a series of rotating shafts to two wheels of the vehicle. Vehicles such as compact cars may use a front wheel drive system with power provided to the two front wheels. In other, often larger vehicles, it is often desirable to incorporate both two-wheel drive and four-wheel drive driving modes, wherein power may be selectively distributed to two wheels in one mode and four wheels in another mode. Vehicles of different sizes often incorporate two-wheel drive of the rear wheels and four-wheel drive for the purpose of enabling better handling during varying traction conditions while still being able to switch to two-wheel drive to reduce fuel consumption and reduce wasted power.

Vehicle powertrain disconnecting systems are typically used to disconnect wheels or axles of an all-wheel-drive (AWD) vehicle from the secondary drive unit when the vehicle is in the two-wheel-drive (2WD) mode. The system can also be used to connect the wheels or axles of an AWD vehicle to the secondary drive unit when the vehicle is in the four-wheel-drive (4WD) mode. In favorable traction conditions, disconnecting in the 2WD mode provides a reduction in transmission losses. In unfavorable traction conditions, connecting in the 4WD mode enables drive to all four vehicle wheels and improves propulsion.

Engagement of 4WD systems may be automatically activated or manually activated. Although automatic 4WD engagement has a number of benefits, such as decreased user interaction, automatic 4WD engagement systems also may have some drawbacks, such as greater manufacturing costs as well as repair and maintenance costs. On the other hand, manually engaged 4WD systems have certain benefits over automatically engaged systems, such as increased reliability and decreased manufacturing and repair costs. Therefore, manual 4WD systems may be desired by users who prefer less complex and more reliable 4WD systems, such as off-road enthusiasts.

For vehicles with switchable drive modes, devices and systems are needed for engaging and disengaging drivetrain components such as axles and shafts. As such, disconnect assemblies are used that often involve a form of clutch that can move to connect or disconnect two rotatable components such as two shafts. The disconnect assemblies can be placed in a variety of areas in the drivetrain of a vehicle, including at the wheel ends, at one or more axles, or along one of the drive shafts. Through the use of disconnect systems, vehicles can be made more versatile by having the ability to switch between different drive modes depending on the driving conditions and operator desire.

In some powertrain disconnecting systems, vacuum directed from the vehicle engine is used as the motive or actuating force that powers the disconnecting systems. In particular, the disconnecting system actuators may be powered by the vacuum. In many systems, the vacuum is directed via a passage from the intake manifold of the gasoline-fueled engine. Due to this, the vacuum level, or amount of force or pressure available from the vacuum, may vary as engine throttle settings change along with engine load. For many engine systems, the vacuum level (amount of pressure available) may be limited or vary due to the effects of altitude. Furthermore, temperature changes can also cause pressure fluctuations in the vacuum level, thereby causing fluctuations in movement of the disconnect actuator which may result in undesirable movement of disconnect components such as the diaphragm and clutch components. Additionally, in some vehicles vacuum may not be readily available since various vehicle accessory systems may not be powered by vacuum, or the vehicle may be designed to remove engine intake connections such as vacuum lines in order to enhance engine control and performance. Finally, vacuum-powered powertrain disconnect systems are becoming less desirable with more advanced vehicle design. As such, powertrain disconnect systems are needed that are powered by sources other than vacuum and feature designs conducive to modern vehicle systems.

Additionally, in other applications, such as other clutching or braking systems, motion may need to be retarded or produced quickly. In one example, electromagnetic coils may be utilized in wet plate clutches or locking differentials. However, the components included in a disconnect system employing electromagnetic coils for initializing transitions between clutch positions may be numerous, complex, and take up significant packaging space, thereby increasing a size of the entire system and reducing flexibility of the disconnect system (e.g., to be used in various applications. The inventors herein have recognized the above issues and developed various approaches to address them.

### SUMMARY

In some aspects, an actuator assembly for an axle disconnect includes a solenoid and a latching system connected to the solenoid. The solenoid includes an electromagnetic coil arranged within a housing, and a solenoid core received within the electromagnetic coil. The solenoid core is adapted to move between a first axial position and a second axial position. The latching system includes a support ring fixed to the housing, a latching ring connected to the solenoid core, and an indexing ring fixed to the housing. The support ring has a first set of teeth extending in a first axial direction. The latching ring has a second set of teeth extending in a second axial direction opposite to the first axial direction and toward the support ring, and a third set of teeth extending in the first axial direction away from the support ring. The indexing ring has a fourth set of teeth extending in the second axial direction toward the third set of teeth of the latching ring.

These and other aspects can include one or more of the following features. The actuator assembly can include a biasing element to bias the solenoid core in the second axial direction. The biasing element can be disposed between the housing and the solenoid core. The biasing element can include a compression spring. The support ring can include a first tooth pattern including a first groove having a first depth and a second groove having a second depth shallower than the first depth, where the first tooth pattern repeats around a circumference of the support ring. The second set of teeth of the latching ring can engage the first groove of the first tooth pattern of the support ring in the first axial position of the solenoid core, and the second set of teeth of the latching ring can engage the second groove of the first tooth pattern of the support ring in the second axial position of the solenoid core. The latching ring can be axially fixed to the solenoid core, where the latching ring moves axially with the solenoid core. The latching ring is rotatable about a longitudinal axis through the solenoid and relative to the support ring and the indexing ring. The latching system can connect to the solenoid at a first longitudinal end of the solenoid, and the actuator assembly can include a shift assembly connected to the solenoid at a second longitudinal end of the solenoid opposite the first longitudinal end, and a clutch ring connected to the shift assembly, where the clutch ring can translate in an axial direction to selectively engage or disengage a drive gear.

Certain aspects encompass a method including connecting an actuator assembly to a clutch ring to selectively engage a rotatable member. The actuator assembly includes a solenoid and a latching system. The solenoid includes an electromagnetic coil arranged within a housing, and a solenoid core received within the electromagnetic coil, where the solenoid core moves between a first axial position and a second axial position. The latching system is connected to the solenoid and includes a support ring fixed to the housing, a latching ring axially fixed to the solenoid core to move axially with the solenoid core, and an indexing ring fixed to the housing. The support ring includes a first set of teeth extending in a first axial direction. The latching ring includes a second set of teeth extending in a second axial direction opposite to the first axial direction and toward the support ring, and a third set of teeth extending in the first axial direction away from the support ring. The indexing ring includes a fourth set of teeth extending in the second axial direction toward the third set of teeth of the latching ring. The method includes moving the solenoid core from the first axial position to the second axial position.

These and other aspects can include one or more of the following features. The method can further include engaging the rotatable member with the clutch ring in response to moving the solenoid core from the first axial position to the second axial position. The method can include biasing, with a biasing element, the solenoid core in the second axial direction. The biasing can include biasing with a bias spring disposed between the housing and the solenoid core. Moving the solenoid core from the first axial position to the second axial position can include energizing the solenoid to move the solenoid core in the first axial direction, rotating the latching ring in response to engagement of the third set of teeth with the fourth set of teeth of the indexing ring, and biasing, with the biasing element, the solenoid core in the second axial direction. The support ring can include a first tooth pattern including a first groove having a first depth and a second groove having a second depth different than the first depth, where the first tooth pattern repeats around a circumference of the support ring. Moving the solenoid core in the first axial direction can include disengaging the second set of teeth of the latching ring from the first groove of the first tooth pattern, and biasing the solenoid core in the second axial direction can include engaging the second set of teeth of the latching ring with the second groove of the first tooth pattern. The method can further include moving the solenoid core from the second axial position to the first axial position. Moving the solenoid core from the second axial position to the first axial position can include energizing the solenoid to move the solenoid core in the first axial direction, further rotating the latching ring in response to engagement of the third set of teeth with the fourth set of teeth of the indexing ring, and biasing, with the biasing element, the solenoid core in the second axial direction. Connecting the actuator assembly to the clutch ring can include connecting, with a shift assembly, the solenoid core to the clutch ring.

In some aspects, an axle disconnect system includes a first rotatable member having first spline teeth, a second rotatable member having second spline teeth, a clutch ring engaged with the first spline teeth and movable into and out of engagement with the second spline teeth, and an actuator assembly for moving the clutch ring. The actuator assembly includes a solenoid operably connected to the clutch ring, and a latching system connected to the solenoid. The solenoid includes an electromagnetic coil arranged within a housing, and a solenoid core received within the electromagnetic coil, where the solenoid core moves between a first axial position and a second axial position. The latching system includes a support ring fixed to the housing, a latching ring connected to the solenoid core, and an indexing ring fixed to the housing. The support ring includes a first set of teeth extending in a first axial direction. The latching ring includes a second set of teeth extending in a second axial direction opposite to the first axial direction and toward the support ring and a third set of teeth extending in the first axial direction away from the support ring. The indexing ring includes a fourth set of teeth extending in the second axial direction toward the third set of teeth of the latching ring.

These, and other aspects, can include one or more of the following features. The axle disconnect system can include a shift assembly connected to the solenoid at a longitudinal end of the solenoid, where the shift assembly includes a rocker operably connecting the solenoid core to the clutch ring. The rocker can include a geared end. The axle disconnect system can include a biasing element disposed between the housing and the solenoid core, where the biasing element biases the solenoid core in a first axial direction.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a front perspective view of an example axle disconnect including a latching solenoid.

FIG. 2 is a front view of the latching solenoid of the example axle disconnect of FIG. 1.

FIG. 3 is a cross-sectional view of the example axle disconnect of FIG. 1.

FIG. 4 is a cross-sectional front view of the latching solenoid of the example axle disconnect of FIG. 1.

FIG. 5A is a cross-sectional front view of the latching solenoid of the example axle disconnect of FIG. 1 shown in an un-latched mode.

FIG. 5B is an isolated view of the latching system of the example axle disconnect of FIG. 1 shown in the un-latched mode;

FIG. 6A is a cross-sectional front view of the latching solenoid of the example axle disconnect of FIG. 1 shown in an extended mode.

FIG. 6B is an isolated view of the latching system of the example axle disconnect of FIG. 1 shown in the extended mode being rotationally indexed toward a latched position.

FIG. 7A is a cross-sectional front view of the latching solenoid of the example axle disconnect of FIG. 1 shown in a latched mode.

FIG. 7B is an isolated view of the latching system of the example axle disconnect of FIG. 1 shown in a latched mode.

FIG. 8 is an isolated view of the latching system of the example axle disconnect of FIG. 1 being rotationally indexed toward an unlatched position.

FIG. 9 is a side view of an example geared rocker.

FIG. 10 is a side view of the example geared rocker of FIG. 9 shown in a rotated position relative to the position of FIG. 9.

FIG. 11 is a flowchart describing an example method for positioning a clutch of an axle disconnect.

Like reference numbers and designations in the various drawings indicate like elements.

### DETAILED DESCRIPTION

This disclosure describes actuator assemblies for axle disconnect systems for clutch actuation, and methods for controlling the disconnect systems. While the disclosure describes axle disconnect systems, such as for wheel end disconnects for a powertrain of a vehicle, the disclosure is applicable to other disconnect implementations that selectively connect and selectively disconnect two rotational components. Axial couplings, or disconnects, are used in vehicles to permit rotation of a wheel or wheel-end without requiring rotation of the entirety of the driveline components of the car, reducing parasitic energy losses when the driveline is not supplying power to the wheel. Wheel-ends are often complex sets of components that are manufactured using complex multi-step processes.

In some implementations, an axle disconnect system for a vehicle includes a first rotatable member, such as an input shaft (e.g., a drive axle), a second rotatable member, such as an output shaft (e.g., a wheel or wheel axle), and an actuator assembly that selectively couples the output shaft to the input shaft to transfer rotational motion and torque between the input shaft and the output shaft. The actuator assembly includes a clutch (in the form of a clutch ring, clutch disc, or other clutch type), a solenoid that can be energized to move the clutch into or out of engagement, and latching system connected to the solenoid to assist in moving and/or positioning the solenoid in one of at least two axial positions. The clutch provides selective connection or disconnection between two rotational components (e.g., shafts), and can take a variety of forms. For example, the clutch can include a clutch ring or clutch disc with splines or teeth, clutch plates or clutch discs with a frictional interface(s), or other mechanisms for selective transmission of rotation from one rotating body to another. The actuator assembly can also include a shift assembly coupled between the solenoid and the clutch to transmit movement and/or position of the solenoid to a corresponding movement and/or position of the clutch relative to the rotating bodies.

The solenoid and latching system, when connected together, can be referred to as a latching solenoid. The latching system positions the solenoid core of the solenoid in a first axial position or a second axial position. In the first axial position, the clutch is in an engaged position where the clutch rotationally couples two rotating bodies. In the second axial position, the clutch is in a disengaged position where the clutch does not rotationally coupled the two rotating bodies. In the solenoid, an electromagnetic coil is energized to move the solenoid core, which engages the latching system for controlling the axial position of the solenoid core, and therefore the axial position of the clutch. For example, energizing the electromagnetic coil moves the solenoid core in a first axial direction, and the latching system positions the solenoid core by controlling an amount of return axial movement of the solenoid core in a second axial direction opposite to the first axial direction. In some instances, the latching system includes a biasing element, such as a bias spring (e.g., compression spring, extension spring, disk spring, wave spring, and/or gas spring) or a magnetic or flux biasing mechanism, that biases the solenoid core in the second axial direction. In some implementations, the solenoid can be a monostable solenoid such that energizing the solenoid causes movement of the solenoid core in one direction, but the latching solenoid can provide a bistable output based on its engagement with the latching system. For example, after deenergizing the solenoid, the latching system biases the solenoid toward a first axial position or a second axial position. In some examples, repeated energizing and deenergizing operations of the solenoid results in cycling the axial position of the solenoid core between the first axial position and the second axial position (e.g., between 4x4 and 4x2 engagement), providing bistable solenoid functionality with the monostable latching solenoid.

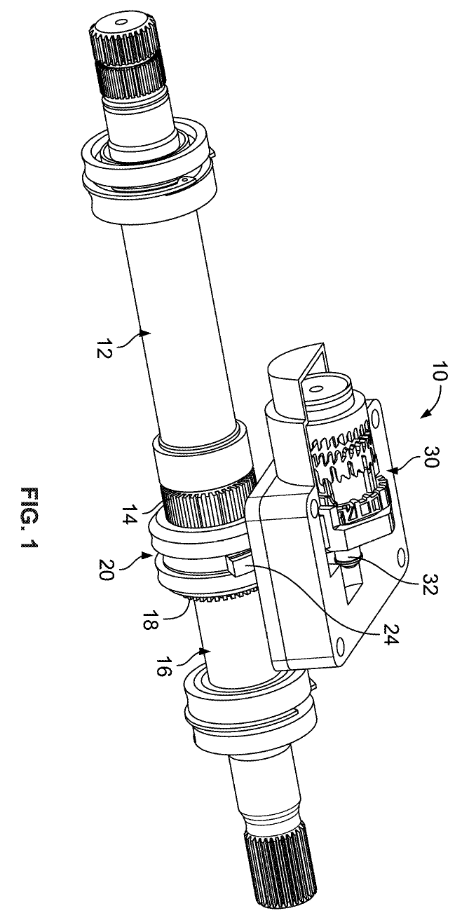

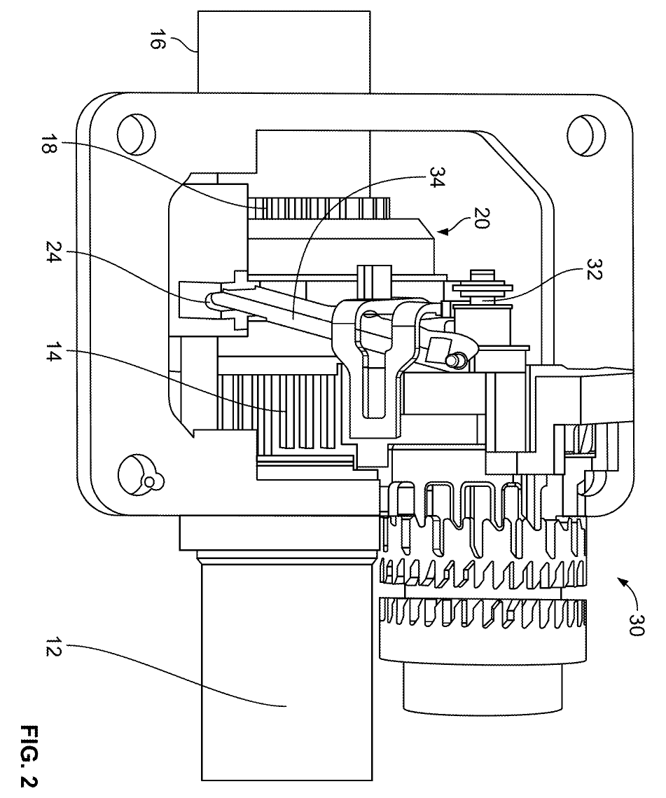

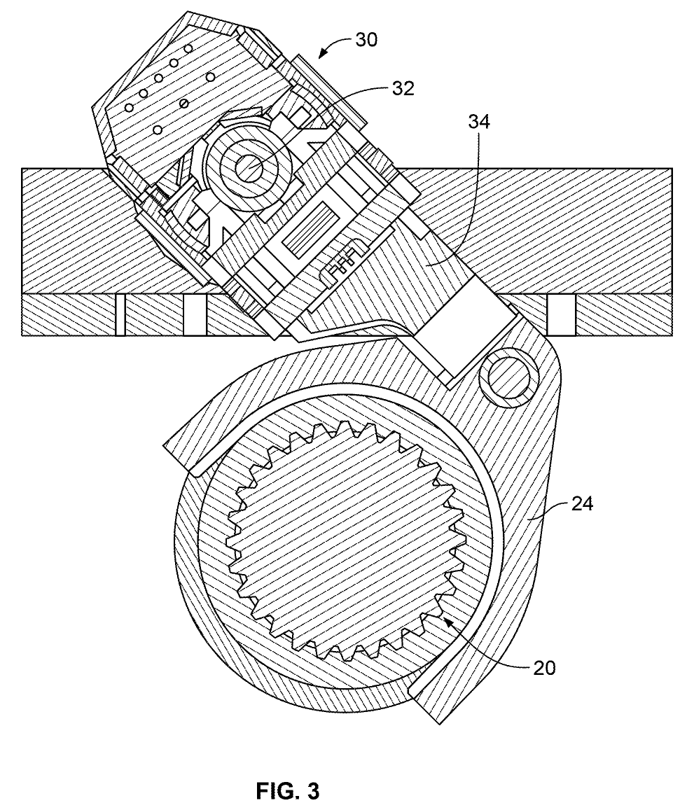

With reference to FIGS. 1-3, an example axle disconnect system 10 is shown including an actuator assembly with a latching solenoid assembly 30. The latching solenoid assembly 30 is formed by a solenoid and a latching system connected to the solenoid, described in greater detail later. The example axle disconnect system 10 further includes a first axle segment 12 having a first external spline portion 14 and a second axle segment 16 with a second external spline portion 18. A clutch ring 20 includes internal splines 22 that engage the second external spline portion 18 of the second axle segment 16 and is movable to also engage the first external spline portion 14 of the first axle segment 12 for coupling the first axle segment 12 to the second axle segment 16. The latching solenoid assembly 30 engages a shift fork 24 that moves the clutch ring 20 into and out of engagement with the first external spline portion 14 of the first axle segment 12. The latching solenoid assembly 30 includes a plunger 32 that is connected to a rocker 34 that engages the shift fork 24. The rocker 34 is pivotably mounted and moves the shift fork 24 in a fore and aft direction in response to the extension and retraction of the solenoid to cause the clutch ring 20 to engage and disengage the first external spline portion 14 of the first axle segment 12.

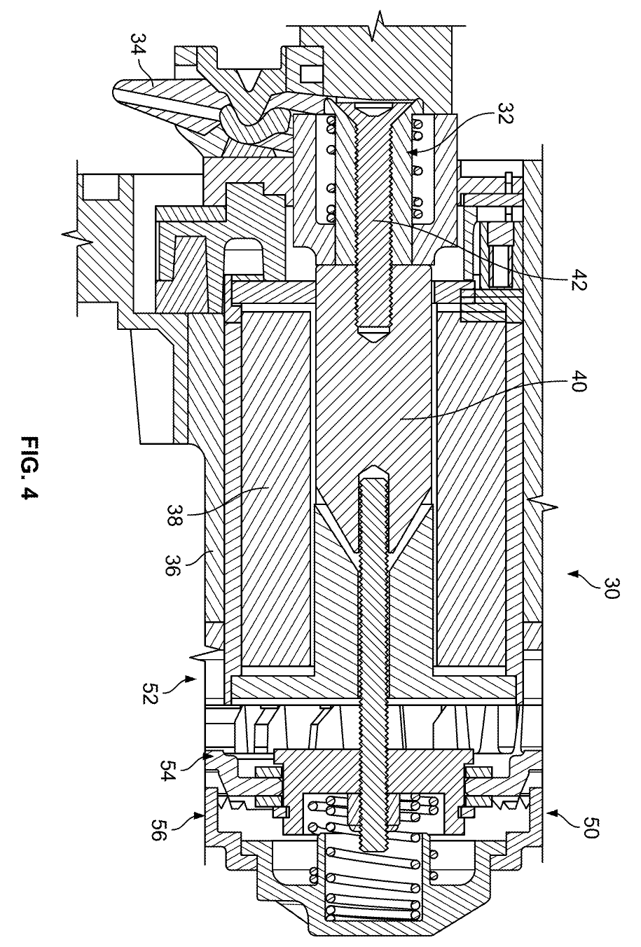

With reference to FIGS. 4-8, the latching solenoid assembly 30 will now be described. As shown in FIG. 4, the latching solenoid assembly 30 includes a housing 36 with an electromagnetic coil 38 mounted within the housing 36. A solenoid core 40 is supported within the housing 36 and is surrounded by the electromagnetic coil 38. Activation of the electromagnetic coil 38 causes fore or aft movement (e.g., axial movement in a first axial direction or second axial direction opposite to the first direction) of the solenoid core 40. One end the solenoid core 40 is connected to the plunger 32 (or another shift assembly type) that causes pivotable movement of the rocker 34. The plunger 32 can be connected to the solenoid core 40 by a threaded fastener 42, as shown, or by other fastening technique. A second end of the solenoid core 40 interfaces with a latching system that includes a latching mechanism 50. The latching system connects to the solenoid, and engages with the solenoid core 40 and the housing 36 to aid in positioning the solenoid core 40 into a first axial position or a second axial position.

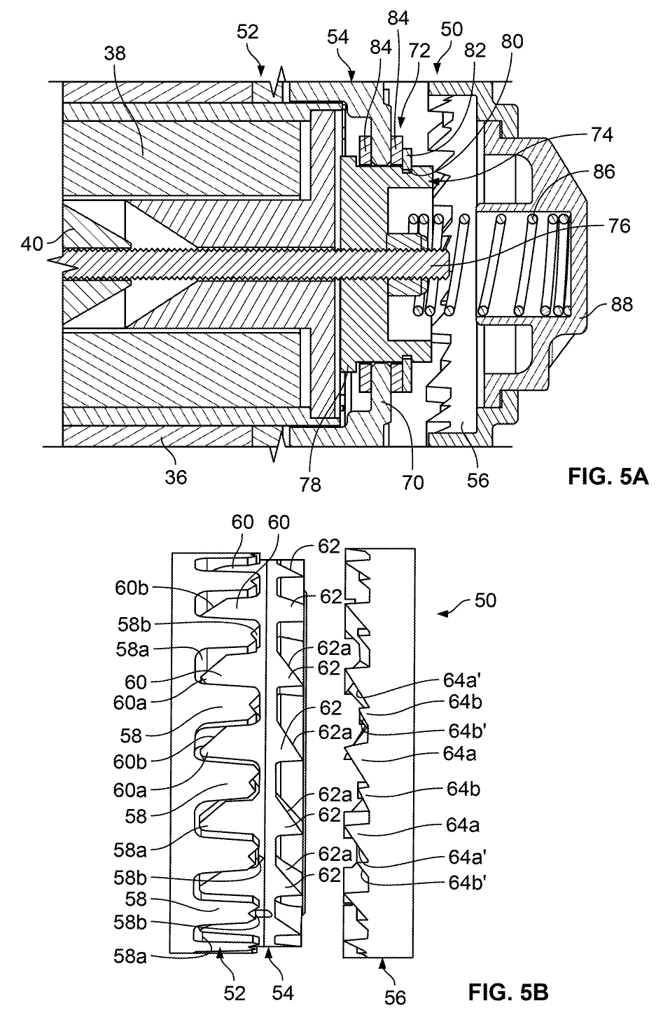

For example, with reference to FIGS. 5A-5B, the latching mechanism 50 is adapted to hold the clutch ring 20 in an engaged position, where the clutch ring 20 is coupled to both the first axle segment 12 and the second axle segment 16, or a disengaged position, where the clutch ring 20 is only coupled to the second axle segment 16 (and not the first axle segment), after energizing the electromagnetic coil 38 to move the clutch ring 20 into either the engaged or disengaged positions and after de-energizing the electromagnetic coil 38. The latching mechanism 50 includes a support ring 52, a latching ring 54 and an indexing ring 56. The support ring 52 includes a first set of teeth 58 arranged on one end of the support ring 52. The first set of teeth 58 includes a first profile with a tooth pattern having two different depth grooves 58a, 58b that repeats around the circumference of the support ring 52. The first grooves 58a are disposed between the teeth 58 and have a greater depth that the second grooves 58b which are formed in a top end of the first set of teeth 58. The support ring 52 is axially fixed relative to the housing 36 of the latching solenoid assembly 30.

The latching ring 54 includes a second set of teeth 60 arranged on a first side of the latching ring 54 and having a second profile with a single, same-depth tooth pattern that repeats around a circumference of the latching ring 54. The second set of teeth 60 have a pointed tip 60a and a sloped cam surface 60b on one lateral side of the pointed tip 60a. The latching ring 54 further includes a third set of teeth 62 arranged on an opposite, second side of the latching ring 54 and having a third profile with a single, same-depth tooth pattern that repeats around a circumference of the latching ring 54. The third set of teeth 62 have a sloped cam surface 62a on one lateral side of a pointed tip 62b.

The indexing ring 56 includes a fourth set of teeth 64 adapted to interface with the third set of teeth 62 of the latching ring 54 to index the indexing ring 56 in two different locking positions. The fourth set of teeth 64 of the indexing ring includes a fourth profile with a tooth pattern having two different indexing teeth 64a, 64b including taller teeth 64a and shorter teeth 64b that repeats around the circumference of the indexing ring 56. The taller teeth 64a and the shorter teeth 64b each include a sloped cam surface 64a1, 64b1 that interface with the sloped cam surface 62a of the third set of teeth 62 of the latching ring 54 to rotationally index the latching ring 54. The indexing ring 56 is fixed to the housing 36 of the latching solenoid assembly 30.

The latching ring 54 is free to move axially between the respective teeth of the support ring 52 and the indexing ring 56 and free to rotate around a central axis, as the latching solenoid assembly 30 is shifted into the different positions, as described further below.

The latching ring 54 includes an internal flange 70 that is connected to the solenoid core 40 by a bearing assembly 72 that allows the latching ring to rotate relative to the solenoid core 40 so that the latching ring 54 is capable of being rotatably indexed relative to the support ring 52. The bearing assembly 72 includes a hub member 74 that is connected to the solenoid core 40 by a fastener 76. The hub member 74 includes a retaining flange 78 and a recessed groove 80 that receives a retaining ring 82 that support a pair of bearing rings 84 on opposite sides of the internal flange 70 of the latching ring 54.

In some implementations, a biasing element biases the solenoid core 40 in an axial direction toward. The biasing element can vary, for example, based on its placement relative to the solenoid and the desired direction of bias. For example, the biasing element can include a bias spring, a magnetic biasing mechanism, or a flux biasing mechanism, to bias the solenoid in a direction. The biasing element applies a biasing force against the solenoid to move in a desired direction, for example, until it reaches a mechanical limit, such as a linear position defined by the latching mechanism. When energized, the solenoid core 40 moves in an opposite direction to the biasing direction of the biasing element, such that the energized solenoid core 40 overcomes the biasing force from the biasing element. In some implementations, the biasing element includes a bias spring, such as a compression spring, extension spring, disk spring, wave spring, gas spring, a combination of these, or another spring element. The bias spring is positioned to apply a biasing force in a desired direction. For example, the bias spring in the form of a compression spring, disk spring, wave spring, and/or gas spring can be disposed between the housing and the solenoid core 40. For example, in the example latching mechanism 50 of FIG. 4, a spring 86 (shown as a compression spring) is supported within a cap 88 of the solenoid housing and biases the hub member 74 and therefore the solenoid core 40 in a leftward direction as shown in the drawing of FIG. 5A. The spring 86 can be a compression spring that provides a continuous bias in the leftward axial direction. In certain implementations, the spring can be an extension spring, which is positioned on an opposite side of the solenoid core 40 to provide the same continuous bias force in the leftward axial direction.

As shown in FIGS. 5A-5B, the second set of teeth of the 60 of the latching ring 54 are fully received in the deeper grooves 58a of the support ring 52. In this, state, the solenoid core is in its leftmost or un-activated position.

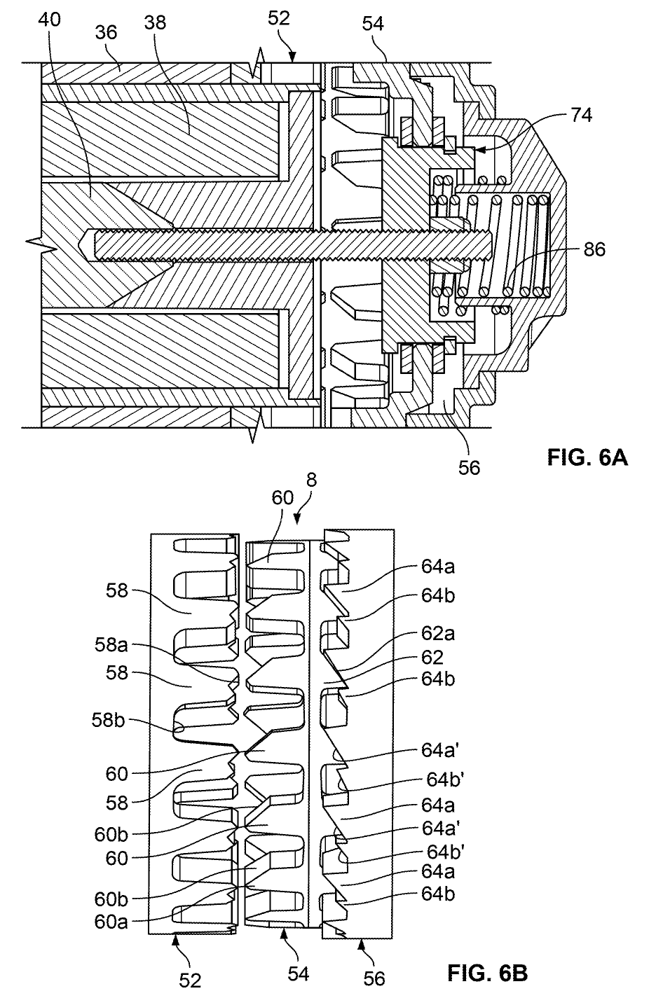

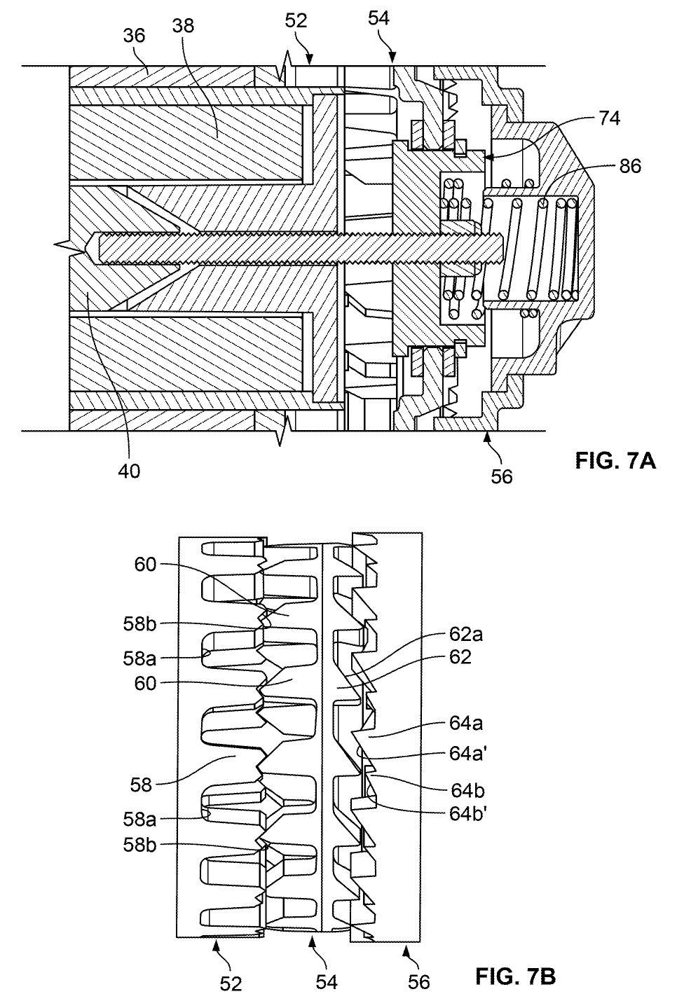

In FIGS. 6A and 6B, the electromagnetic coil 38 has been activated so the solenoid core 40 is moved to an engaged position (rightmost position in FIG. 6A) and the sloped cam surface 62a of the third set of teeth 62 of the latching ring 54 are moved into engagement with the sloped cam surface 64a1 of the taller teeth 64a of the indexing ring so that the latching ring 54 is indexed so that the tip 60a of the second set of teeth 60 align with the shallower grooves 58b of the first set of teeth 58 on the support ring 52. As the electromagnetic coil 38 is no longer activated, the spring 86 biases the latching ring 54 back toward the support ring 52 so that the tips 60a of the second set of teeth of the 60 of the latching ring 54 are received in the shallower grooves 58b of the support ring 52, as shown in FIG. 7B in order to hold the solenoid core 40 in the activated position without having to maintain the electromagnetic coil 38 in an activated state.

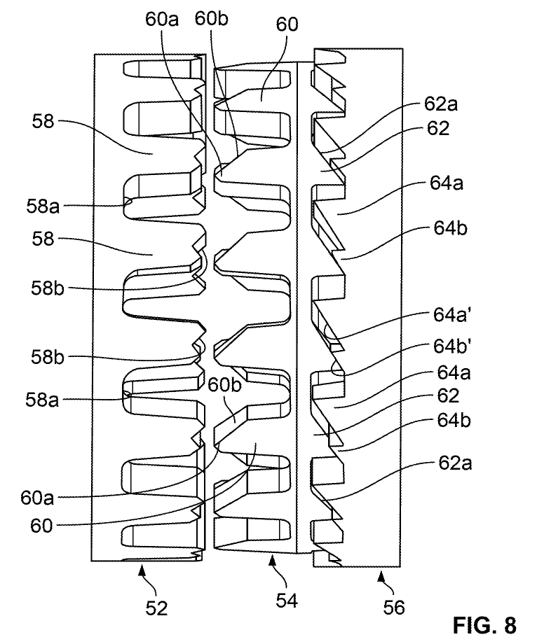

As shown in FIG. 8, when the electromagnetic coil 38 is again activated so the solenoid core 40 is moved to an engaged position and the sloped cam surface 62a of the third set of teeth 62 of the latching ring 54 are moved into engagement with the sloped cam surface 64b1 of the shorter teeth 64b of the indexing ring 56, the latching ring 54 is again indexed so that the second set of teeth 60 align with the deeper grooves 58a of the first teeth 58 on the support ring 52. As the electromagnetic coil is no longer activated, the spring 86 biases the latching ring 54 back toward the support ring 52 so that the second set of teeth 60 of the latching ring 54 are received in the deeper grooves 58a of the support ring 52, as shown in FIG. 5B in order to hold the solenoid core 40 in the inactivated position.

In an example operation, where the support ring 52 has the dual tooth pattern that repeats around a circumference of the support ring 52, the second plurality of teeth of the latching ring 54 engage the first groove of the first tooth pattern of the support ring 52 in the first axial position of the solenoid core 40, and the second plurality of teeth of the latching ring 54 engage the second groove of the first tooth pattern of the support ring 52 in the second axial position of the solenoid core. The latching ring 54 is axially fixed to the solenoid core to move axially with the solenoid core 40, and the latching ring 54 is rotatable about the central axis through the solenoid and relative to the fixed support ring 52 and the fixed indexing ring 56. The bias spring biases the solenoid core 40 in a second axial direction, for example, to move the solenoid core 40 in the second axial direction when the solenoid is not energized. For example, moving the solenoid core 40 from the first axial position to the second axial position can include energizing the solenoid to move the solenoid core 40 in the first axial direction, rotating the latching ring 54 in response to engagement of the third plurality of teeth with the fourth plurality of teeth of the indexing ring 56, and biasing, with the bias spring, the solenoid core 40 in the second axial direction. Moving the solenoid core 40 in the first axial direction can include disengaging the second plurality of teeth of the latching ring 54 from the first groove of the tooth pattern of the support ring 52, and biasing the solenoid core 40 in the second axial direction includes engaging the second plurality of teeth of the latching ring 54 with the second groove of the tooth pattern of the support ring 52. The solenoid core 40 can be further moved from the second axial position to the first axial position, for example, by energizing the solenoid to move the solenoid core 40 in the first axial direction, further rotating the latching ring 54 in response to engagement of the third plurality of teeth with the fourth plurality of teeth of the indexing ring 56, and biasing, with the bias spring, the solenoid core 40 in the second axial direction such that the teeth of the latching ring engage the next groove of the tooth pattern of the support ring 52.

It should be noted that the latching mechanism can take on alternative forms. Where the stepped teeth (having two different depth grooves) can be provided on the latching ring 54 and the support ring has a single tooth profile. It should be further noted that the function of the indexing ring can be implemented without a ring structure but instead with indexing features or teeth supported on the solenoid housing.

Although the embodiment shown in FIGS. 1-3 of the present application show the latching solenoid assembly 30 utilized on an axle disconnect, the latching solenoid assembly can be utilized as an actuator on other systems for moving a clutch ring or other engagement mechanism. For example, the latching solenoid assembly 30 can be utilized for moving a clutch ring of a differential disconnect, a wheel end disconnect, and other similar type systems. The latching solenoid assembly 30 can be actuated and released to allow the latching solenoid assembly 30 to move to an engaged and a disengaged position without requiring the electromagnetic coil to be maintained in an actuated state.

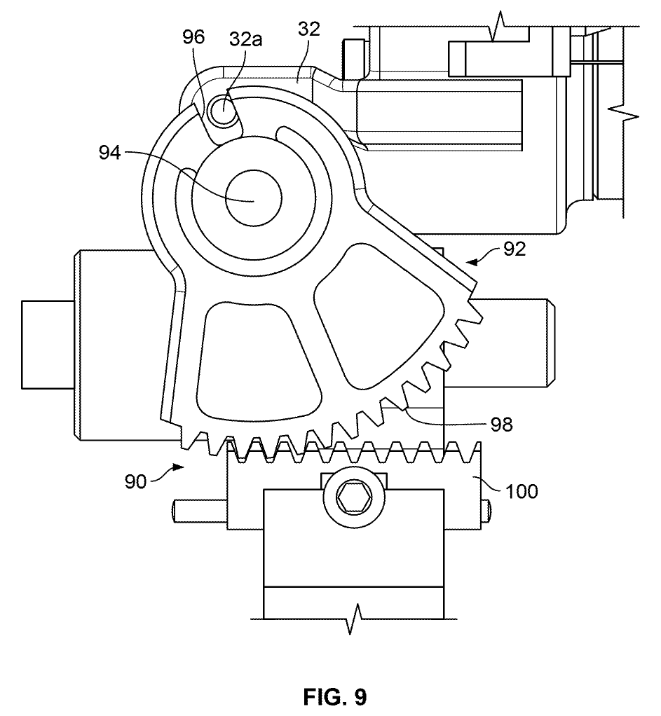

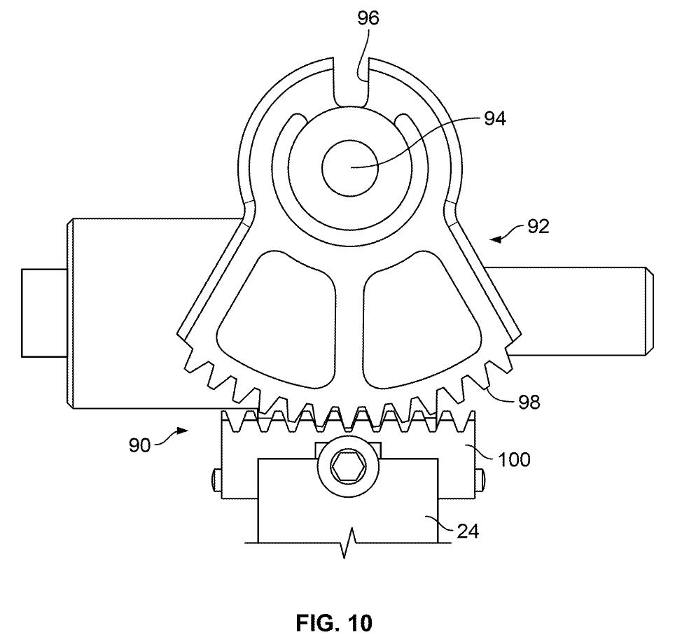

The embodiment of FIG. 4 shows a rocker 34 pivotably mounted to move the shift fork 24 in a fore and aft direction in response to the extension and retraction of the solenoid core 40 in order to cause the clutch ring 20 to engage and disengage the first external spline portion 14 of the first axle segment 12. According to an alternative embodiment as shown in FIGS. 9 and 10, a rack and pinion system 90 is shown for translating a linear movement of the plunger 32 of the solenoid 30 into an offset linear movement of the shift fork. The rack and pinion system 90 includes a geared rocker 92 pivotally mounted to a pivot 94 and having a slot 96 on a first end for receiving a pin 32a of the plunger 32 and having a pinion or geared segment 98 on a second end. The geared segment 98 is in meshing engagement with a rack 100 that is connected to a shift fork 24 for moving a clutch ring 20.

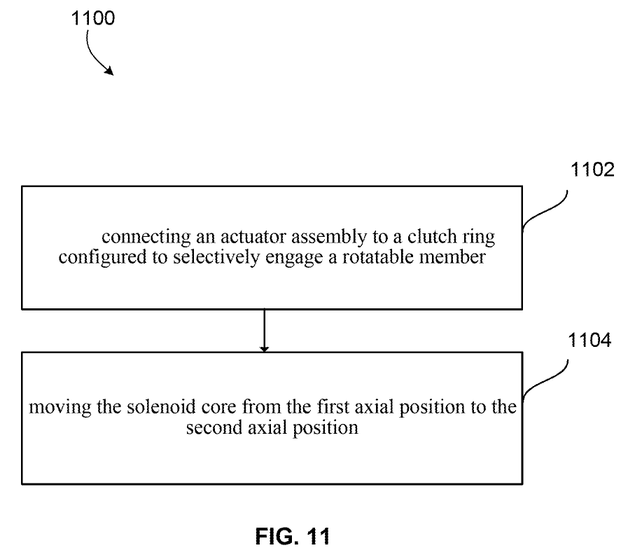

FIG. 11 is a flowchart illustrating an example method 1100 for positioning a clutch of an axle disconnect, for example, performed by the example axle disconnect system 10 of FIGS. 1-10. At 1102, an actuator assembly connects to a clutch ring that selectively engages a rotatable member. The solenoid includes an electromagnetic coil arranged within a housing, and a solenoid core received within the electromagnetic coil, where the solenoid core is adapted to move between a first axial position and a second axial position. The latching system is connected to the solenoid and includes a support ring, a latching ring, and an indexing ring. The support ring is fixed to the housing and includes a first plurality of teeth extending in a first axial direction. The latching ring has a second plurality of teeth extending in a second axial direction opposite to the first axial direction and toward the support ring and a third plurality of teeth extending in the first axial direction away from the support ring, and the latching ring is axially fixed to the solenoid core to move axially with the solenoid core. The indexing ring is fixed to the housing and has a fourth plurality of teeth extending in the second axial direction toward the third plurality of teeth of the latching ring. At 1104, the solenoid core moves from the first axial position to the second axial position.

The rotatable member can engage with the clutch ring in response to the movement of the solenoid core from the first axial position to the second axial position. In some implementations, a biasing element biases the solenoid core in the second axial direction, for example, to move the solenoid core in the second axial direction when the solenoid is not energized. The biasing element can include a bias spring disposed between the housing and the solenoid core, where the bias spring biases the solenoid core in the second axial direction. For example, moving the solenoid core from the first axial position to the second axial position can include energizing the solenoid to move the solenoid core in the first axial direction, rotating the latching ring in response to engagement of the third plurality of teeth with the fourth plurality of teeth of the indexing ring, and biasing, with the biasing element, the solenoid core in the second axial direction. The support ring includes a first tooth pattern including a first groove having a first depth and a second groove having a second depth different than the first depth, and the first tooth pattern repeats around a circumference of the support ring. Moving the solenoid core in the first axial direction can include disengaging the second plurality of teeth of the latching ring from the first groove of the first tooth pattern, and biasing the solenoid core in the second axial direction includes engaging the second plurality of teeth of the latching ring with the second groove of the first tooth pattern. The solenoid core can be further moved from the second axial position to the first axial position, for example, by energizing the solenoid to move the solenoid core in the first axial direction, further rotating the latching ring in response to engagement of the third plurality of teeth with the fourth plurality of teeth of the indexing ring, and biasing, with the biasing element, the solenoid core in the second axial direction. The actuator assembly is connected to the clutch ring, for example, with a shift assembly that couples the solenoid core to the clutch ring.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms "a,” "an," and "the" may be intended to include the plural forms as well, unless the context clearly indicates otherwise. The terms "comprises," "comprising," “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being "on," “engaged to,” "connected to," or "coupled to" another element or layer, it may be directly on, engaged, connected or coupled to the other element or layer, or intervening elements or layers may be present. In contrast, when an element is referred to as being "directly on," “directly engaged to,” "directly connected to," or "directly coupled to" another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term "and/or" includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” "beneath," "below," "lower," "above," "upper," and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as "below" or "beneath" other elements or features would then be oriented "above" the other elements or features. Thus, the example term "below" can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The foregoing description is provided in the context of one or more particular implementations. Various modifications, alterations, and permutations of the disclosed implementations can be made without departing from scope of the disclosure. Thus, the present disclosure is not intended to be limited only to the described or illustrated implementations, but is to be accorded the widest scope consistent with the principles and features disclosed herein.

What is claimed is:

1. An actuator assembly for an axle disconnect, the actuator assembly comprising:
a solenoid comprising:
an electromagnetic coil arranged within a housing; and
a solenoid core received within the electromagnetic coil, the solenoid core adapted to move between a first axial position and a second axial position; and
a latching system connected to the solenoid, the latching system comprising:
a support ring fixed to the housing and including a first plurality of teeth extending in a first axial direction;
a latching ring having a second plurality of teeth extending in a second axial direction opposite to the first axial direction and toward the support ring and a third plurality of teeth extending in the first axial direction away from the support ring, the latching ring being connected to the solenoid core; and
an indexing ring fixed to the housing and having a fourth plurality of teeth extending in the second axial direction toward the third plurality of teeth of the latching ring.

2. The actuator assembly of claim 1, further comprising a biasing element configured to bias the solenoid core in the second axial direction.

3. The actuator assembly of claim 2, wherein the biasing element is disposed between the housing and the solenoid core.

4. The actuator assembly of claim 2, wherein the biasing element comprises a compression spring.

5. The actuator assembly of claim 1, wherein the support ring comprises a first tooth pattern including a first groove having a first depth and a second groove having a second depth shallower than the first depth, and the first tooth pattern repeats around a circumference of the support ring.

6. The actuator assembly of claim 5, wherein the second plurality of teeth of the latching ring engage the first groove of the first tooth pattern of the support ring in the first axial position of the solenoid core, and the second plurality of teeth of the latching ring engage the second groove of the first tooth pattern of the support ring in the second axial position of the solenoid core.

7. The actuator assembly of claim 1, wherein the latching ring is axially fixed to the solenoid core, the latching ring adapted to move axially with the solenoid core.

8. The actuator assembly of claim 1, wherein the latching ring is rotatable about a longitudinal axis through the solenoid and relative to the support ring and the indexing ring.

9. The actuator assembly of claim 1, wherein the latching system connects to the solenoid at a first longitudinal end of the solenoid, the actuator assembly comprising:
a shift assembly connected to the solenoid at a second longitudinal end of the solenoid opposite the first longitudinal end; and
a clutch ring connected to the shift assembly, the clutch ring configured to translate in an axial direction to selectively engage or disengage a drive gear.

10. A method, comprising:
connecting an actuator assembly to a clutch ring configured to selectively engage a rotatable member, the actuator assembly comprising:
a solenoid comprising:
an electromagnetic coil arranged within a housing; and
a solenoid core received within the electromagnetic coil, the solenoid core adapted to move between a first axial position and a second axial position; and
a latching system connected to the solenoid, the latching system comprising:
a support ring fixed to the housing and including a first plurality of teeth extending in a first axial direction;
a latching ring having a second plurality of teeth extending in a second axial direction opposite to the first axial direction and toward the support ring and a third plurality of teeth extending in the first axial direction away from the support ring, the latching ring being axially fixed to the solenoid core to move axially with the solenoid core; and
an indexing ring fixed to the housing and having a fourth plurality of teeth extending in the second axial direction toward the third plurality of teeth of the latching ring; and
moving the solenoid core from the first axial position to the second axial position.

11. The method of claim 10, further comprising engaging the rotatable member with the clutch ring in response to moving the solenoid core from the first axial position to the second axial position.

12. The method of claim 10, comprising biasing, with a biasing element, the solenoid core in the second axial direction.

13. The method of claim 12, wherein the biasing comprises biasing with a bias spring disposed between the housing and the solenoid core.

14. The method of claim 12, wherein moving the solenoid core from the first axial position to the second axial position comprises:
energizing the solenoid to move the solenoid core in the first axial direction,
rotating the latching ring in response to engagement of the third plurality of teeth with the fourth plurality of teeth of the indexing ring, and
biasing, with the biasing element, the solenoid core in the second axial direction.

15. The method of claim 14, wherein the support ring comprises a first tooth pattern including a first groove having a first depth and a second groove having a second depth different than the first depth, and the first tooth pattern repeats around a circumference of the support ring;
wherein moving the solenoid core in the first axial direction comprising disengaging the second plurality of teeth of the latching ring from the first groove of the first tooth pattern; and
wherein biasing the solenoid core in the second axial direction comprises engaging the second plurality of teeth of the latching ring with the second groove of the first tooth pattern.

16. The method of claim 14, further comprising moving the solenoid core from the second axial position to the first axial position.

17. The method of claim 16, wherein moving the solenoid core from the second axial position to the first axial position comprises:
energizing the solenoid to move the solenoid core in the first axial direction,
further rotating the latching ring in response to engagement of the third plurality of teeth with the fourth plurality of teeth of the indexing ring, and
biasing, with the biasing element, the solenoid core in the second axial direction.

18. The method of claim 10, wherein connecting the actuator assembly to the clutch ring comprises connecting, with a shift assembly, the solenoid core to the clutch ring.

19. An axle disconnect system, comprising:
a first rotatable member having first spline teeth;
a second rotatable member having second spline teeth;
a clutch ring engaged with the first spline teeth and movable into and out of engagement with the second spline teeth; and
an actuator assembly for moving the clutch ring, the actuator assembly comprising:
a solenoid operably connected to the clutch ring, the solenoid comprising:
an electromagnetic coil arranged within a housing; and
a solenoid core received within the electromagnetic coil, the solenoid core adapted to move between a first axial position and a second axial position; and
a latching system connected to the solenoid, the latching system comprising:
a support ring fixed to the housing and including a first plurality of teeth extending in a first axial direction;
a latching ring having a second plurality of teeth extending in a second axial direction opposite to the first axial direction and toward the support ring and a third plurality of teeth extending in the first axial direction away from the support ring, the latching ring being connected to the solenoid core; and
an indexing ring fixed to the housing and having a fourth plurality of teeth extending in the second axial direction toward the third plurality of teeth of the latching ring.

20. The axle disconnect system of claim 19, comprising a shift assembly connected to the solenoid at a longitudinal end of the solenoid, the shift assembly comprising a rocker operably connecting the solenoid core to the clutch ring.

21. The axle disconnect system of claim 20, wherein the rocker comprises a geared end.

22. The axle disconnect system of claim 19, further comprising a biasing element disposed between the housing and the solenoid core, the biasing element configured to bias the solenoid core in a first axial direction.
